(19) United States
(12) Patent Application Publication
(10) Pub. No.: US 2003/0149555 A1
(43) Pub. Date: Aug. 7, 2003

(54) Method of simulation

(75) Inventor: Kenichiro Sonoda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, TOKYO (JP)

(21) Appl. No.: 10/202,165

(22) Filed: Jul. 25, 2002

(30) Foreign Application Priority Data
Feb. 6, 2002 (JP) 2002-029529

(51) Int. Cl. G06F 17/50

(52) U.S. Cl. 703/15

(57) ABSTRACT

A method of simulating a memory transistor is provided. An Id-Vcg characteristic is obtained by actual measurement in Step s2, and an Id-Vfg characteristic is obtained by actual measurement in Step s4. Based on the obtained Id-Vcg and Id-Vfg characteristics, the value of a capacitance (Cfc) for use in circuit simulation of the memory transistor is determined in Step s5. In Step s14, the circuit simulation is performed using the value of the capacitance (Cfc) determined in Step s5. This allows a simulated value to reliably approach a measured value since the determined capacitance (Cfc) is based on a result of actual measurement of the characteristics of the memory transistor.

### BACKGROUND OF THE INVENTION

1. Field of the Invention

The present invention relates to a method of simulating a memory transistor including a control gate, a floating gate, and a substrate having a source region and a drain region formed in a surface thereof.

2. Description of the Background Art

FIG. 15 is a sectional view showing a structure of a memory transistor 10 constituting a memory cell of a semiconductor non-volatile memory such as an EPROM (erasable programmable read-only memory), an EEPROM (electrically erasable programmable read-only memory) and a flash memory. As shown in FIG. 15, the memory transistor 10 comprises a control gate 5, a floating gate 4, a substrate 1 having a source region 3, a drain region 2 and a channel region 8 formed in a surface thereof, and insulation films 6, 7. The memory transistor 10 stores information therein by injection of electrons into the floating gate 4.

The source region 3 and the drain region 2 formed in the surface of the substrate 1 are spaced a predetermined distance apart from each other. The channel region 8 is defined between the drain region 2 and the source region 3, and an inversion layer is formed in the channel region 8 when a predetermined voltage is applied to the control gate 5. The insulation film 7, the floating gate 4, the insulation film 6 and the control gate 5 are disposed in a stacked relation in the order named from the substrate 1 side on the surface of the substrate 1 between the source region 3 and the drain region 2, i.e. on the channel region 8. The floating gate 4, the insulation film 7 and the substrate 1 constitute a MOS transistor structure 9. Although not shown for purposes of illustration, the floating gate 4, in general, is fully covered with an insulation film.

A method of simulating the memory transistor 10 as described above has been proposed such that the memory transistor 10 is represented by a model, for example, shown in FIG. 16, and a circuit simulation is performed using the model. Specifically, the memory transistor 10 is represented by a model having a MOS transistor 100, a capacitance Cfc and a current source 110, as illustrated in FIG. 16. FIG. 17 shows only the MOS transistor 100 extracted out of the model of the memory transistor 10 shown in FIG. 16. In FIG. 17, a capacitance Cox is the gate capacitance of the MOS transistor 100.

The MOS transistor 100 corresponds to the MOS transistor structure 9 of the memory transistor 10, and the above-mentioned capacitance Cox represents the gate capacitance of the MOS transistor structure 9 of the memory transistor 10. The capacitance Cfc represents a capacitance defined between the floating gate 4 and the control gate 5, that is, the capacitance of a capacitor constructed by the floating gate 4, the control gate 5 and the insulation film 6. The current source 110 represents a gate current flowing between the channel region 8 and the floating gate 4. Methods of injecting electrons into the floating gate 4 in the memory transistor 10 are of the following types: a method which uses hot electrons and a method which uses tunneling current. The current source 110 shown in FIG. 16 represents the gate current when the method which uses hot electrons is employed to inject electrons into the floating gate 4. Substantially similar description about the model shown in FIG. 16 is disclosed in F. Gigon, “Modeling and Simulation of the 16 Megabit Eprom Cell for Write/Read Operation with a Compact Spice Model,” in IEDM Tech. Dig., pp. 205-208, 1990.

A transistor model representing a characteristic of only the MOS transistor 100 in the model shown in FIG. 16, that is, the MOS transistor structure 9 in the transistor 10 has already been proposed in the form of a model equation. A method of determining a parameter (known as a “transistor parameter”) in the model equation has also already been established. Specifically, a standard transistor 20 is prepared which is a MOS transistor identical in construction with the MOS transistor structure 9 of the memory transistor 10, as shown in FIG. 18, and an electrical characteristic of the standard transistor 20 is measured. Using the measurement result, a parameter in the model equation representing a characteristic of the MOS transistor 100 is determined. A floating gate 14 shown in FIG. 18 corresponds to the floating gate 4 of the memory transistor 10, and an insulation film 17 shown in FIG. 18 corresponds to the insulation film 7 of the memory transistor 10. A substrate 11 shown in FIG. 18 with a source region 13 and a drain region 12 formed in a surface thereof corresponds to the substrate 1 of the memory transistor 10. The model shown in FIG. 17 is also a model representing the standard transistor 20.

As stated above, the model equation representing the characteristic of only the MOS transistor structure 9 in the memory transistor 10 and the method of determining the parameter in the model equation have already been established. However, other techniques including a method of determining a value required to perform a circuit simulation of the memory transistor 10, and a model representing a parameter required to perform the circuit simulation of the memory transistor 10 have not yet been established. Specifically, a method of determining the value of, for example, the capacitance Cfc of FIG. 16 and a model representing the current source 110 of FIG. 16 or the gate current have not yet been established. In other words, a method of simulating the memory transistor 10 has not yet been established under present circumstances.

### SUMMARY OF THE INVENTION

It is an object of the present invention to provide a method of simulating a memory transistor which is capable of reliably causing a simulated value obtained when a circuit simulation of a memory transistor is performed to approach a measured value of a characteristic of the memory transistor.

A first aspect of the present invention is intended for a method of simulating a memory transistor including a control gate, a floating gate, and a substrate having a source region and a drain region formed in a surface thereof, the floating gate and the substrate constituting a MOS transistor structure. The method includes the following steps (a) to (e). The step (a) is to prepare the memory transistor. The step (b) is to obtain a relationship between a potential of the control gate with respect to the source region and a drain current by actual measurement for the memory transistor. The step (c) is to prepare a standard transistor having the same structure as the MOS transistor structure of the memory transistor. The step (d) is to obtain a relationship between a potential of the floating gate with respect to the source region and a drain current by actual measurement for the standard transistor. The step (e) is to determine a capacitance value defined between the control gate and the floating gate in the memory transistor for use in a circuit simulation of the memory transistor, based on a result obtained in the step (b) and a result obtained in the step (d). In the method, the circuit simulation of the memory transistor is performed using the capacitance value determined in the step (e).

The value of the capacitance defined between the control gate and the floating gate in the memory transistor for use in the circuit simulation of the memory transistor is determined in the step (e), based on the relationship between the potential of the control gate with respect to the source region and the drain current which is obtained by actual measurement and the relationship between the potential of the floating gate with respect to the source region and the drain current which is obtained by actual measurement. Then, the circuit simulation is performed using the value of the capacitance determined in the step (e). This allows a simulated value to reliably approach an actually measured value of a characteristic of the memory transistor.

A second aspect of the present invention is intended for a method of simulating a memory transistor including a control gate, a floating gate, and a substrate having a source region and a drain region formed in a surface thereof, the floating gate and the substrate constituting a MOS transistor structure. The method includes the following steps (a) to (d). The step (a) is to prepare the memory transistor. The step (b) is to obtain a relationship between a threshold voltage and one of the time for which an electron is injected into the floating gate and the time for which an electron is emitted from the floating gate by actual measurement for the memory transistor. The step (c) is to obtain a relationship between a gate current flowing between a floating gate and a channel region defined between the source region and the drain region, and a potential of the floating gate with respect to the source region for the memory transistor by using a result obtained in the step (b). The step (d) is to determine a value of a parameter in a model equation representing the gate current, based on a result obtained in the step (c). In the method, a circuit simulation of the memory transistor is performed using the model equation in which the value determined in the step (d) is substituted for the parameter.

The relationship (Ig-Vfg characteristic) between the gate current and the potential of the floating gate with respect to the source region is obtained in the step (c) by the use of the relationship between the threshold voltage and the time for which the electron is injected into or emitted from the floating gate which is obtained by actual measurement. Then, the value of the parameter in the model equation representing the gate current is determined in the step (d), based on the Ig-Vfg characteristic obtained in the step (c). In other words, the step (d) uses the Ig-Vfg characteristic based on the result of actual measurement of the characteristic of the memory transistor to determine the value of the parameter in the model equation representing the gate current. The circuit simulation is performed using the model equation in which the value determined in the step (d) is substituted for the parameter. This allows the simulated value to reliably approach the actually measured value of the characteristic of the memory transistor.

A third aspect of the present invention is intended for the method of simulating a memory transistor including a control gate, a floating gate, and a substrate having a source region and a drain region formed in a surface thereof, the memory transistor storing information therein by injection of a hot electron from a channel region defined between the drain region and the source region into the floating gate. The method includes performing a circuit simulation of the memory transistor using a model equation representing a channel electric field at a point of injection of the hot electron into the floating gate in the channel region. The model equation is expressed by

E=(Vd−Vdsat)/lc

for Vfg>Vd−V1, and

E=(Vd−Vdsat)/lc×(1−a×(Vd−Vfg−V1)/(Vd+c))

for Vfg≦Vd−V1, where

E=the channel electric field at the point of injection of the hot electron into the floating gate in the channel region;

Vfg=a potential of the floating gate with respect to the source region;

Vd=a potential of the drain region with respect to the source region;

Vdsat=a potential of the drain region with respect to the source region at pinchoff; and

V1, lc, a and c=fitting parameters.

The method according to the present invention reliably provides the simulated value closer to the actually measured value than a method which uses a channel electric field at a drain region end as the channel electric field at the point of injection of the hot electron into the floating gate, thereby producing a good simulation result.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart showing a method of simulation according to a first preferred embodiment of the present invention;

FIGS. 2 and 3 are graphs showing an Id-Vcg characteristic and an Id-Vfg characteristic according to the first preferred embodiment;

FIGS. 4 and 5 are graphs showing a relationship between Vcg and Vfg according to the first preferred embodiment;

FIG. 6 is a flowchart showing a method of simulation according to a second preferred embodiment of the present invention;

FIG. 7 is a graph showing a Vth-t characteristic according to the second preferred embodiment;

FIG. 8 is a flowchart showing a method of simulation according to the second preferred embodiment;

FIG. 9 is a graph showing an Ig-Vfg characteristic according to the second preferred embodiment;

FIG. 10 is a flowchart showing a method of simulation according to a third preferred embodiment of the present invention;

FIG. 11 shows a table for use in the method of simulation according to the third preferred embodiment;

FIGS. 12A and 12B are graphs showing an Ig-Vd characteristic of a memory transistor;

FIG. 13 is a graph showing an Ig-Vfg characteristic according to a fourth preferred embodiment of the present invention;

FIG. 14 is a graph showing a Vth-t characteristic according to the fourth preferred embodiment;

FIG. 15 is a sectional view showing a structure of a memory transistor;

FIG. 16 is a diagram showing a model of the memory transistor;

FIG. 17 is a diagram showing a model of a standard transistor; and

FIG. 18 is a sectional view showing a structure of the standard transistor.

### DESCRIPTION OF THE PREFERRED EMBODIMENTS

First Preferred Embodiment

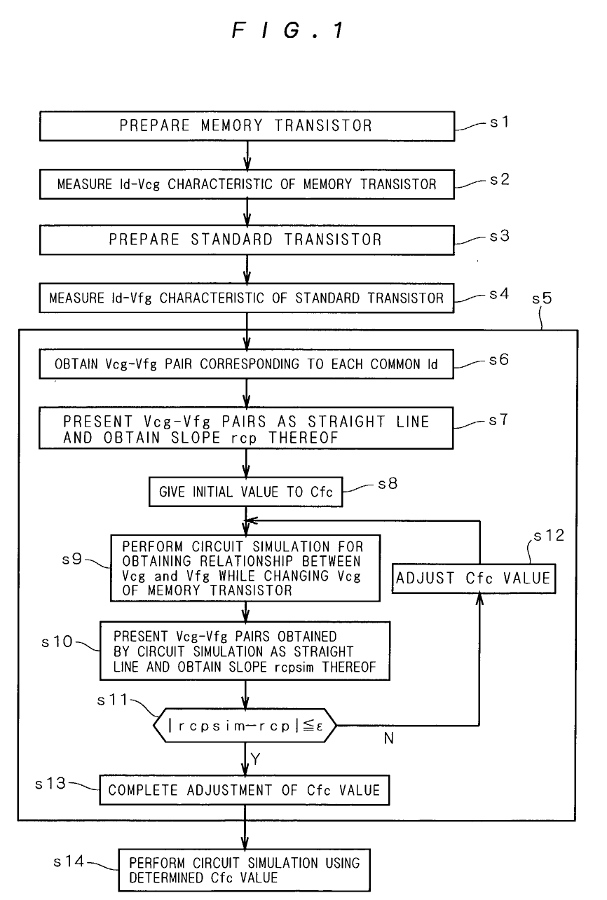

FIG. 1 is a flowchart showing a method of simulating a memory transistor according to a first preferred embodiment of the present invention. The method of simulating the memory transistor according to the first preferred embodiment includes determining the capacitance Cfc shown in FIG. 16 or the capacitance defined between the control gate and the floating gate in the memory transistor for use in a circuit simulation of the memory transistor, based on a measured value of a characteristic of the memory transistor, and performing a circuit simulation of the memory transistor using the determined value of the capacitance Cfc. Detailed description will now be given on the method of simulating the memory transistor according to the first preferred embodiment with reference to FIG. 1.

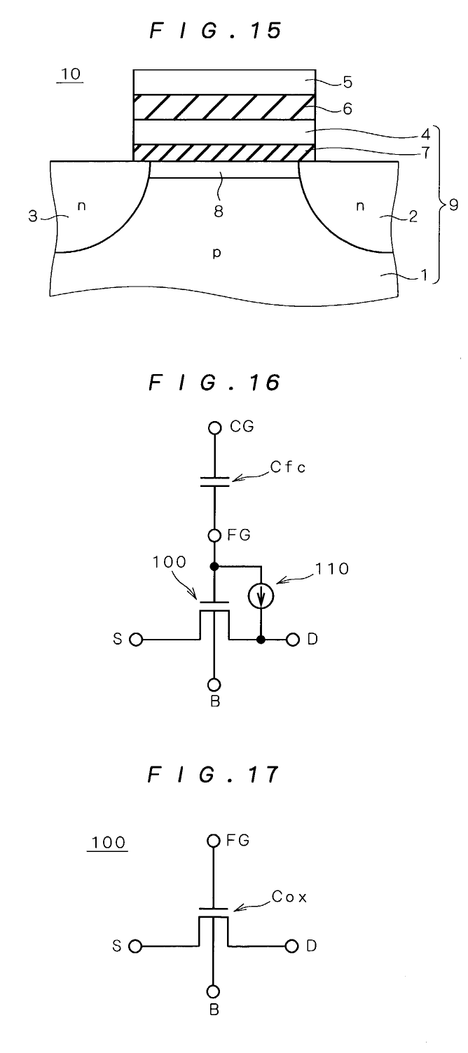

As shown in FIG. 1, a memory transistor as shown in FIG. 15 is prepared in Step s1. Specifically, a memory transistor is prepared which is manufactured under the same manufacturing conditions as a memory transistor in a semiconductor non-volatile memory product. In Step s2, a relationship between a potential of the control gate with respect to a source region and a drain current is obtained by actual measurement for the prepared memory transistor. The potential of the control gate with respect to the source region is represented by “Vcg,” and the drain current is represented by “Id.” The relationship between Vcg and Id is referred to as an “Id-Vcg characteristic.”

Step s2 will be more specifically described. The Id-Vcg characteristic is obtained by making actual measurements of Id as a function of Vcg while changing a voltage applied to the control gate of the memory transistor or the value of Vcg. Points of measurement for the obtained Id-Vcg characteristic are represented by “measurement points i” (where i is a variable). The number of measurement points i is represented by “m,” and Vcg and Id at the measurement points i are represented by Vcg[i] and Idc[i] (where i=1, . . . , m), respectively.

In Step s3, a standard transistor as shown in FIG. 18 is prepared. Specifically, a standard transistor is prepared which is manufactured under the same manufacturing conditions as a MOS transistor structure of a memory transistor in a semiconductor non-volatile memory product. In Step s4, a relationship between a potential of the floating gate with respect to a source region and Id is obtained by actual measurement for the prepared standard transistor. The potential of the floating gate with respect to the source region is represented by “Vfg,” and the relationship between Vfg and Id is referred to as an “Id-Vfg characteristic.”

Step s4 will be more specifically described. The Id-Vfg characteristic is obtained by making actual measurements of Id as a function of Vfg while changing a voltage applied to the floating gate of the standard transistor or the value of Vfg. Points of measurement for the obtained Id-Vfg characteristic are represented by “measurement points j” (where j is a variable). The number of measurement points j is represented by “n,” and Vfg and Id at the measurement points j are represented by Vfg[j] and Idf[j] (where j=1, . . . , n), respectively.

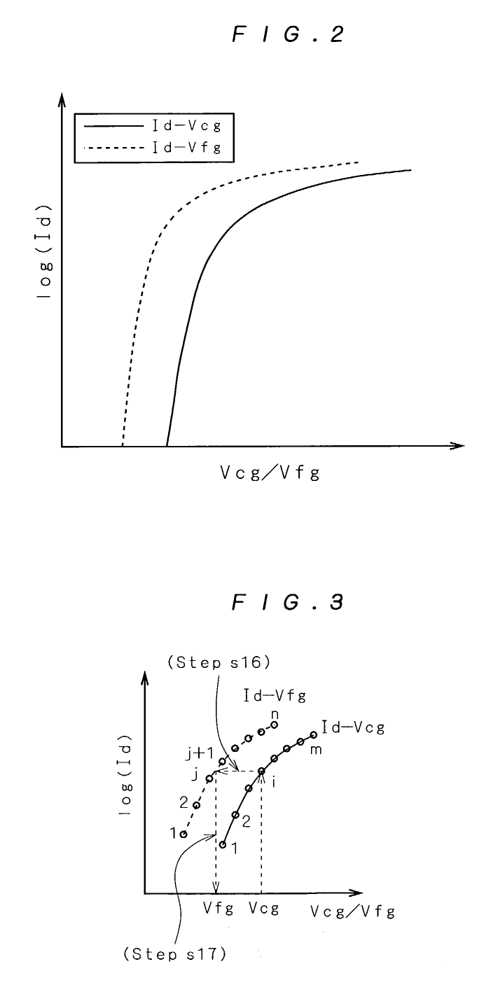

FIG. 2 is a graph showing an example of the Id-Vcg characteristic obtained in Step s2 and an example of the Id-Vfg characteristic obtained in Step s4. The solid line of FIG. 2 indicates the Id-Vcg characteristic, and the broken line of FIG. 2 indicates the Id-Vfg characteristic. The ordinate, or Id, is logarithmically represented.

Next, in Step s5, the value of the capacitance Cfc is determined based on the results obtained in Steps s2 and s4, that is, the Id-Vcg and Id-Vfg characteristics. Specifically, Step s5 includes Steps s6 through s13. In Step s6, a pair of values of Vcg and Vfg corresponding to a common value of Id are obtained by a method shown in FIG. 3. More specifically, a judgment is made as to whether or not the Id-Vfg characteristic has a segment connecting adjacent measurement points and including a value of Id equal to Idc[i] at a measurement point i of the Id-Vcg characteristic, as shown in FIG. 3 (which step is referred to hereinafter as “Step s16”). If the Id-Vfg characteristic has such a segment, the value of Vfg corresponding to the value of Id equal to Idc[i] is obtained from the Id-Vfg characteristic by logarithmical interpolation, and the value of Vcg[i] corresponding to Idc[i] and the value of Vfg obtained by the logarithmic interpolation are stored as a pair (which step is referred to hereinafter as “Step s17”).

In Step s6 according to the first preferred embodiment, Steps s16 and s17 are executed for each value of i changing from 1 to m to obtain pairs of values of Vcg and Vfg corresponding to respective common values of Id. If the Id-Vfg characteristic does not have the above-mentioned segment, it is impossible to obtain the value of Vfg corresponding to the value of Id equal to Idc[i] at that time. In this case, the value of i is changed without executing Step s17, and then Step s16 is executed.

The value of Vfg is obtained by

$$Vfg = \frac{log ( Idf [ j + 1 ] / Id ) \times Vfg [ j ] + log ( Id / Idf [ j ] ) \times Vfg [ j + 1 ]}{log ( Idf [ j + 1 ] / Idf [ j ] )} \qquad ( 1 )$$

where Vfg[j], Idf[j], Vfg[j+1], Idf[j+1] in Equation (1) represent Vfg and Id at adjacent measurement points j and j+1 defining a segment of the Id-Vfg characteristic including the value of Id equal to Idc[i], as shown in FIG. 3.

Next, in Step s7, the Vcg-Vfg pairs obtained in Step s6 are presented as a straight line expressed by Equation (2) below, and the slope rcp of the straight line is obtained.

Vfg=rcp×Vcg+Vfgini (2)

where Vfgini is a potential generated by the initial charge stored in the floating gate at the beginning of measurement of the Id-Vcg characteristic.

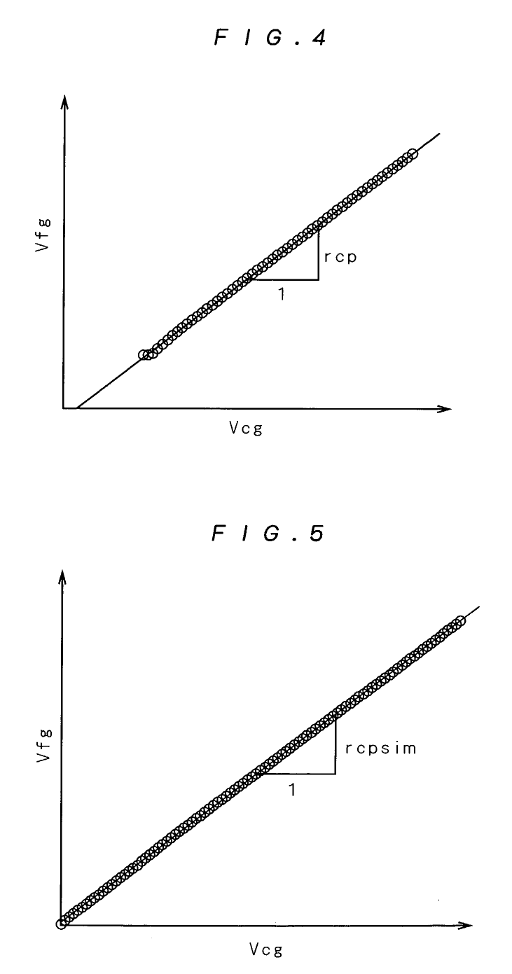

FIG. 4 is a graph indicating Equation (2). Circles in FIG. 4 represent the pairs of Vcg and Vfg values obtained in Step s6.

In Step s8, an initial value is given to the capacitance Cfc. In Step s9, a circuit simulation for obtaining the relationship between Vcg and Vfg is performed while changing the Vcg of the memory transistor by using the capacitance Cfc. FIG. 5 is a graph showing a result of the circuit simulation performed in Step s9. Circles in FIG. 5 represent the pairs of Vcg and Vfg values obtained by the circuit simulation. The gate current which is a very small current as compared with Id and the like is regarded as zero in the circuit simulation performed in Step s9 according to the first preferred embodiment.

The initial value for the capacitance Cfc used herein includes, for example, a value calculated by regarding a structure constituted by the floating gate, the control gate and the insulation film therebetween as a parallel-plate capacitor. The circuit simulation performed in Step s9 employs a transistor model known as, for example, a “BSIM3 model” for the MOS transistor structure of the memory transistor, to obtain the relationship between Vcg and Vfg by using the “BSIM3 model” and the capacitance Cfc.

The “BSIM3 model” is a model equation which represents Id of the MOS transistor by the use of a potential (referred to hereinafter as “Vg”) of the gate with respect to the source region, a potential (referred to hereinafter as “Vd”) of the drain region with respect to the source region, and a potential (referred to hereinafter as “Vb”) of the substrate with respect to the source region. The value of a transistor parameter in the model equation is determined, for example, in a manner to be described below. With the values of Vd and Vb fixed, actual measurement of Id is made while changing Vg to obtain a relationship (referred to hereinafter as an “Id-Vg characteristic”) between Vg and Id. Then, with the values of Vg and Vb fixed, actual measurement of Id is made while changing Vd to determine a relationship (referred to hereinafter as an “Id-Vd characteristics”) between Vd and Id. The value of the transistor parameter is determined so that the Id-Vg characteristic and the Id-Vd characteristic both obtained by actual measurements match with characteristics given from the model equation.

According to the first preferred embodiment, Vg in the “BSIM3 model” corresponds to Vfg. Thus, the relationships between Id and Vfg, between Id and Vd, and between Id and Vb are obtained by the use of the “BSIM3 model” according to the first preferred embodiment. The relationship between Vcg and Vfg is obtained by the circuit simulation using the “BSIM3 model” and the capacitance Cfc.

Next, in Step s10, the slope rcpsim of a straight line consisting of the Vcg-Vfg pairs obtained in Step s9 is determined. The slope rcpsim is illustrated in FIG. 5. Then, in Step s11, a comparison is made between the value of the slope rcp obtained in Step s7 and the value of the slope rcpsim obtained in Step s9. Specifically, a judgment is made as to whether or not the absolute value of the difference between the slopes rcpsim and rcp is greater than a reference value ε. The reference value ε used herein is, for example, “0.05.” If the absolute value is not greater than the reference value ε as a result of the judgment, adjustment of the capacitance Cfc is completed in Step s13, and the value of the capacitance Cfc is determined. On the other hand, if the absolute value is greater than the reference value ε as a result of the judgment, the value of the capacitance Cfc is adjusted in Step s12. The adjustment is made specifically such that the value of the capacitance Cfc is increased if the value of the slope rcp is greater than the value of the slope rcpsim, and is decreased if the value of the slope rcp is less than the value of the slope rcpsim. Then, Step s9 is executed using the adjusted capacitance Cfc.

After the completion of the adjustment of the capacitance Cfc in Step s13 or the determination of the value of the capacitance Cfc in Step s5, the circuit simulation of the memory transistor is performed using the determined value of the capacitance Cfc in Step s14.

The method of simulating the memory transistor according to the first preferred embodiment as above described determines the value of the capacitance Cfc for use in the circuit simulation of the memory transistor, based on the Id-Vcg characteristic and the Id-Vfg characteristic both obtained by actual measurement in Step s5. Then, the value of the capacitance Cfc obtained in Step s5 is used to perform the circuit simulation in Step s14. This makes a simulated value of the memory transistor close to an actually measured value. In other words, the method of simulating the memory transistor according to the first preferred embodiment can reliably cause the simulated value to approach the actually measured value of a characteristic of the memory transistor.

Second Preferred Embodiment

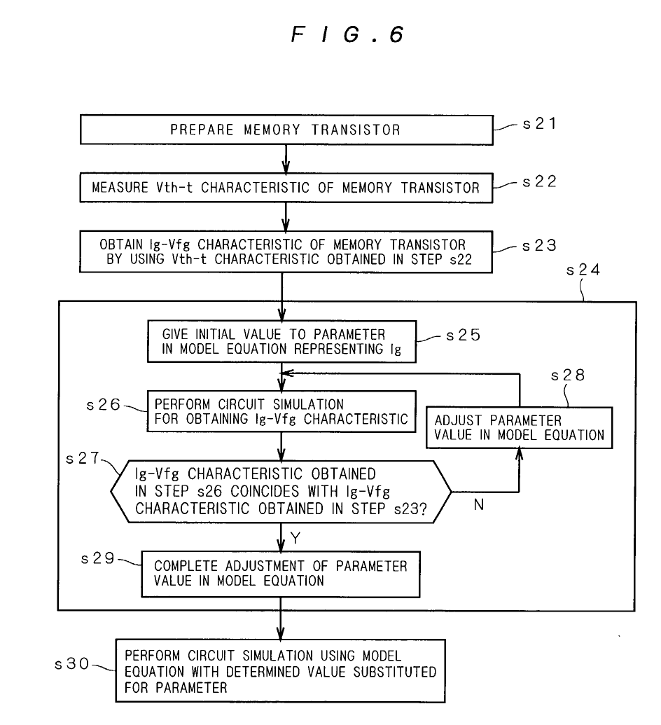

FIG. 6 is a flowchart showing a method of simulating a memory transistor according to a second preferred embodiment of the present invention. The method of simulating the memory transistor according to the second preferred embodiment includes determining the value of a parameter in a model equation representing the gate current of the memory transistor, based on a result of actual measurement of a characteristic of the memory transistor, and performing the circuit simulation of the memory transistor by using the model equation with the determined value substituted for the parameter. Detailed description will now be given on the method of simulating the memory transistor according to the second preferred embodiment with reference to FIG. 6.

As shown in FIG. 6, a memory transistor as shown in FIG. 15 is prepared in Step s21. Specifically, a memory transistor is prepared which is manufactured under the same manufacturing conditions as a memory transistor in a semiconductor non-volatile memory product. In Step s22, a relationship between the time for which electrons are injected into or emitted from the floating gate and a threshold voltage is obtained by actual measurement for the prepared memory transistor. The threshold voltage of the memory transistor is represented by “Vth.” The time for which electrons are injected into the floating gate is referred to as “electron injection time,” and the time for which electrons are emitted from the floating gate is referred to as “electron emission time.” The relationship between the electron injection time or electron emission time and Vth is referred to as a “Vth-t characteristic.” For a memory transistor which writes information by the injection of electrons into the floating gate and erases information by the emission of electrons from the floating gate, the above-mentioned electron injection time means the time which elapses since the beginning of writing into the memory transistor, and the electron emission time means the time which elapses since the beginning of erasure of the memory transistor.

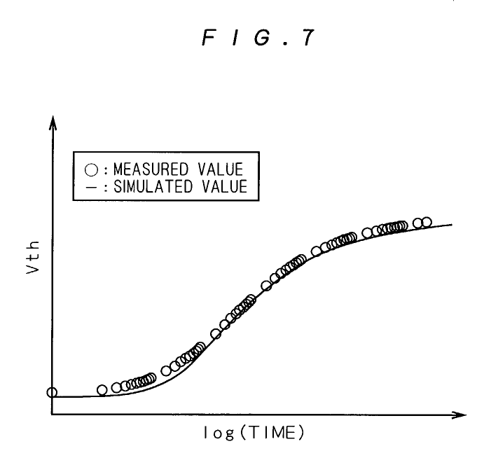

Specific description is given on Step s22, for example, in the case of the injection of electrons into the floating gate. First, Vcg, Vd and Vb are set at respective predetermined values, and electrons are injected into the floating gate for a length of time ΔT in seconds. Then, Vd and Vb are set at respective values which do not cause the injection and emission of electrons into and from the floating gate, and the value of Id is actually measured while changing Vcg. The value of Vcg when Id measures a predetermined current value, e.g. 1 μA, is stored as Vth. Electrons are further injected into the floating gate for the length of time ΔT in seconds, and then Vth is stored. Repeating such an operation provides the Vth-t characteristic. FIG. 7 shows the Vth-t characteristic of the memory transistor. Circles in FIG. 7 represent the measured values thus obtained. The ordinate of FIG. 7 represents the logarithm of the electron injection time, and the solid line represents a simulated value to be described later. The electron injection time or electron emission time at each measurement point for the Vth-t characteristic is represented by t[i], and Vth corresponding to t[i] is represented by Vth[i] where i=1, . . . , m and “m” is the number of measurement points. Thus, Vth[i] corresponding to t[i] refers to Vth obtained when electrons are injected into or emitted from the floating gate for a length of time t[i] in seconds.

Next, in Step s23, a relationship between the gate current of the memory transistor and Vfg is obtained using the result of Step s22 or the Vth-t characteristic. The gate current is represented by “Ig,” and the relationship between Ig and Vfg is referred to as an “Ig-Vfg characteristic.”

Step s23 will be described in detail. First, dVth[i] is calculated by

dVth[i]=Vth[i]−Vth0(i=1, . . . , m) (3)

where Vth0 is the value of Vth obtained at the time the injection or emission of electrons into or from the floating gate is started, that is, the initial value of Vth. Vth[1] may be used in place of Vth0 in Equation (3).

Then, Vfg and Ig are calculated respectively by

$$\begin{matrix}Vfg [ j ] = rcp \times Vcg + Vfgini - rcp \times ( dVth [ j ] + dVth [ j + 1 ] ) / 2 \\ ( j = 1 , … , m - 1 ) & ( 4 ) \\ Ig [ j ] = - Cfc \times \frac{dVth [ j + 1 ] - dVth [ j ]}{t [ j + 1 ] - t [ j ]} ( j = 1 , … , m - 1 ) & ( 5 )\end{matrix}$$

and the Ig-Vfg characteristic is obtained.

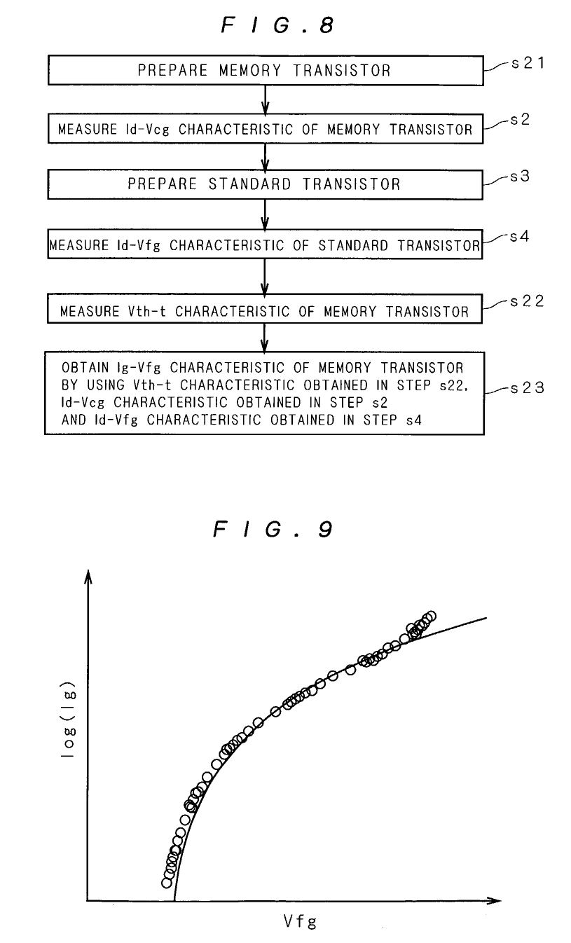

Empirically determined values may be used for rcp and Vfgini in Equation (4) and the capacitance Cfc in Equation (5). Steps s2 through s4 of FIG. 1 may be added to the method of simulation according to the second preferred embodiment, in which case the values of rcp, Vfgini and the capacitance Cfc are determined using the Id-Vcg characteristic resulting from Step s2 and the Id-Vfg characteristic resulting from Step s4 as in the first preferred embodiment, and the values thus determined are used. Thus, in Step s23 according to the second preferred embodiment, the Ig-Vfg characteristic may be obtained either by using the Vth-t characteristic resulting from Step s22 and the empirically determined values or by using the Vth-t characteristic resulting from Step s22, the Id-Vcg characteristic resulting from Step s2 and the Id-Vfg characteristic resulting from Step s4. FIG. 8 is a partial flowchart showing the method of simulation according to the second preferred embodiment to which Steps s2 through s4 of FIG. 1 are added to obtain the Ig-Vfg characteristic in Step s23 by using the Vth-t characteristic, the Id-Vcg characteristic and the Id-Vfg characteristic. Steps subsequent to Step s23 of FIG. 8 are identical with those of FIG. 6.

FIG. 9 is a graph showing the Ig-Vfg characteristic. Circles in FIG. 9 represent the values of Ig and Vfg obtained in Step s23. The ordinate of FIG. 9 represents the logarithm of Ig, and the solid line represents a simulated value to be described later.

The process of deriving Equation (4) will be discussed. As stated above, Vfg can be expressed by Equation (2). When the injection or emission of electrons into or from the floating gate proceeds and Vth is changed by ΔVth from its initial value, Vth is expressed by

$$\begin{matrix}Vfg = rcp \times ( Vcg - Δ Vth ) + Vfgini \\ = rcp \times Vcg + Vfgini - rcp \times Δ Vth\end{matrix} \qquad ( 6 )$$

It should be noted that, in the process of deriving Equation (5) to be described later, the “initial value” shall mean a value obtained at the time the injection or emission of electrons into or from the floating gate is started.

For time coincidence with Ig expressed in Equation (5), the use of the average value of dVth[j] and dVth[j+1] as ΔVth results in Equation (4).

Next, the process of deriving Equation (5) will be discussed. A change ΔQfg in the quantity of electric charge in the floating gate from its initial value is expressed by

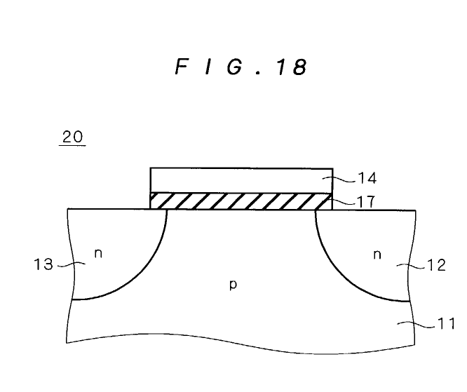

ΔQfg=(Cox+Cfc)×ΔVfg (7)

where ΔVfg is a change in Vfg from its initial value, and the capacitance Cox corresponds to the capacitance Cox in FIG. 17. Then, Ig which is the time derivative of ΔQfg is expressed by

Ig=d(ΔQfg)/dt=(Cox+Cfc)×d(ΔVfg)/dt (8)

From Equation (6), ΔVfg is expressed by

$$\begin{matrix}Δ Vfg = rcp \times ( Vcg - Δ Vth ) + Vfgini - Vfgini \\ = rcp \times ( Vcg - Δ Vth )\end{matrix} \qquad ( 9 )$$

where rcp is expressed by

rcp=Cfc/(Cox+Cfc) (10)

Using Equations (9) and (10), Equation (8) is rewritten as

Ig=−Cfc×d(ΔVth)/dt (11)

Since ΔVth is a change in Vth from its initial value, Equation (5) is derived from Equation (11).

Next, in Step s24, the values of parameters in the model equation representing Ig is determined based on the result obtained in Step s23 or the Ig-Vfg characteristic. An example of the model equation representing Ig for use in the second preferred embodiment is as follows:

Ig=A(Vfg−B)^{C}×Vd^{D}×Vb^{E} (12)

where the parameters A, B, C, D and E are fitting parameters to be adjusted according to the measured value of the characteristic of the memory transistor. In Step s24, the parameters A to E are determined.

Specifically, Step s24 includes Steps s25 through s29. First, in Step s25, initial values are given to the parameters in the model equation representing Ig, i.e. the above-mentioned parameters A to E. An example of the method of giving the initial values is as follows: The initial values of the parameters B and C are determined from the Ig-Vfg characteristic obtained in Step s23. Although Vd and Vb are set at fixed values when determining the Vth-t characteristic in Step s22, a relationship (referred to hereinafter as an “Ig-Vd characteristic”) between Vd and Ig and a relationship (referred to hereinafter as an “Ig-Vb characteristic”) between Vb and Ig are obtained by changing the setting of Vd or Vb and obtaining the Vth-t characteristic under the conditions after the change. The initial value of the parameter D is determined from the obtained Ig-Vd characteristic, and the initial value of the parameter E is determined from the Ig-Vb characteristic. The initial values of the parameters B to E are substituted into Equation (12), and the initial value of the parameter A is determined, for example, so that the Ig-Vfg characteristic to be obtained from Equation (12) approaches the obtained Ig-Vfg characteristic.

Next, in Step s26, a circuit simulation for obtaining the Ig-Vfg characteristic is performed using Equation (12) with the initial values given to the parameters A to E. The solid line of FIG. 9 shows the simulated result. In Step s27, a judgment is made as to whether or not the Ig-Vfg characteristic obtained in Step s23 coincides with the Ig-Vfg characteristic obtained by the simulation in Step s26. This judgment is specifically made such that the value of ε is calculated, for example, using Equation (13) below, and it is judged that the coincidence results if the value of ε is, for example, less than 0.05; otherwise it is not so judged.

$$ϵ = \sqrt{\frac{1}{N} {\sum }_{k = 1}^{N} {( \frac{Igsim [ k ] - Igmeas [ k ]}{Igmeas [ k ]} )}^{2}} \qquad ( 13 )$$

where Igsim[k] and Igmeas[k] refer to Ig obtained in Step s26 and Ig obtained in Step s23 which provide the same value of Vfg, and N=m−1.

If it is not judged in Step s27 that the result obtained in Step s26 coincides with the result obtained in Step s23, the values of the parameters A to E in the model equation are adjusted in Step s28. Then, in Step s26, the circuit simulation for obtaining the Ig-Vfg characteristic is performed using Equation (12) including the adjusted parameters A to E. On the other hand, if it is judged in Step s27 that the result obtained in Step s26 coincides with the result obtained in Step s23, the process proceeds to Step s29 wherein the adjustment of the values of the parameters A to E is completed, and the values of the parameters A to E are determined.

After the completion of the adjustment of the values of the parameters A to E in Step s29 or the determination of the values of the parameters A to E in Step s24, the circuit simulation of the memory transistor, for example, for determining the Vth-t characteristic is performed in Step s30 by using Equation (12) with the determined values substituted for the parameters A to E. The solid line of FIG. 7 indicates the Vth-t characteristic obtained by the simulation. As illustrated in FIG. 7, the simulated value is close to the actually measured value according to the second preferred embodiment.

The method of simulation according to the second preferred embodiment as above described determines the Ig-Vfg characteristic in Step 23 using the Vth-t characteristic obtained by actual measurement. Then, the values of the parameters in the model equation representing Ig are determined in Step s24, based on the Ig-Vfg characteristic obtained in Step s23. That is, Step s24 uses the Ig-Vfg characteristic based on the result of actual measurement of the characteristic of the memory transistor to determine the values of the parameters in the model equation representing Ig. Then, in Step s30, the circuit simulation is performed in Step s30 using the model equation in which the values determined in Step s24 are substituted for the parameters. This makes the simulated value of the memory transistor close to the actually measured value. In other words, the method of simulating the memory transistor according to the second preferred embodiment can reliably cause the simulated value to approach the actually measured value of the characteristic of the memory transistor.

The use of the empirically determined values and the use of the values determined using the method of simulation of the first preferred embodiment as the values of rcp and Vfgini in Equation (4) and the capacitance Cfc in Equation (5) are described according to the second preferred embodiment. When the method of simulation of the first preferred embodiment is used, the values for rcp, Vfgini and Cfc are based on the result of actual measurement of the memory transistor characteristic. This allows the Ig-Vfg characteristic obtained in Step s23 to be reliably closer to the actual Ig-Vfg characteristic of the memory transistor than that provided by the use of the empirically determined values. In other words, the use of the results obtained in Steps s22, s2 and s4 (see FIG. 8) in Step s23 allows the Ig-Vfg characteristic obtained in Step s23 to be reliably closer to the actual Ig-Vfg characteristic of the memory transistor than the use of the result obtained in Step s22 and the empirically determined values.

Although Equation (12) is adopted as the model equation representing Ig according to the second preferred embodiment, other model equations may be used instead. Specifically, for simulation of a memory transistor (referred to hereinafter as a “hot electron type memory transistor”) which stores information therein by the injection of hot electrons from the channel region into the floating gate, Equation (12a) disclosed in, for example, S. Tam et al., “Lucky-Electron Model of Channel Hot-Electron Injection in MOSFET's,” IEEE Trans. Electron Devices, Vol. ED-31, No. 9, pp. 1116-1125, 1984 (referred to hereinafter as “Reference [1]”) may be adopted as the model equation representing Ig of the memory transistor. In this case, values described in Reference [1] may be used as the initial values of the parameters in the model equation set in Step s25.

The model equation representing Ig adopted in the second preferred embodiment, i.e., Equation (12) is expressed by the product of A, (Vfg−B)^{C}, Vd^{D} and Vb^{E}. In this equation, (Vfg−B)^{C} is a kind of polynomial involving Vfg, Vd^{D} is a kind of polynomial involving Vd, and Vb^{E} is a kind of polynomial involving Vb. Thus, it can be said that Equation (12) is expressed by the product of a polynomial involving Vfg, a polynomial involving Vd and a polynomial involving Vb.

Unlike the model equation adopted in the second preferred embodiment, the model equation representing Ig or Equation (12a) in Reference [1] contains variables such as Vfg and Vb in the exponent for the base “e.” Thus, when Equation (12a) in Reference [1] is adopted as the model equation according to the second preferred embodiment, it is difficult to adjust the values of the parameters in the model equation in Step s28. Specifically, when a change is made in the values of the parameters in Equation (12), it is difficult to estimate how the characteristic of Ig represented by Equation (12a) is accordingly changed.

However, since Equation (12) adopted in the second preferred embodiment is expressed by the product of polynomials as described above, it is easy to estimate the characteristic of Ig after the change in the values of the parameters in Equation (12). This facilitates the adjustment of the values of the parameters in the model equation, to allow the parameters in the model equation to be more easily determined than in a model equation containing a variable such as Vfg in the exponent for a certain base.

Third Preferred Embodiment

FIG. 10 is a flowchart showing a method of simulating a memory transistor according to a third preferred embodiment of the present invention. Although the circuit simulation is performed using the model equation as the model representing Ig in the method of simulation according to the second preferred embodiment, the method of simulation according to the third preferred embodiment performs a circuit simulation using a model which obtains the value of Ig by interpolation from values in a table as the model representing Ig. Detailed description will now be given on the method of simulating the memory transistor according to the third preferred embodiment with reference to FIG. 10.

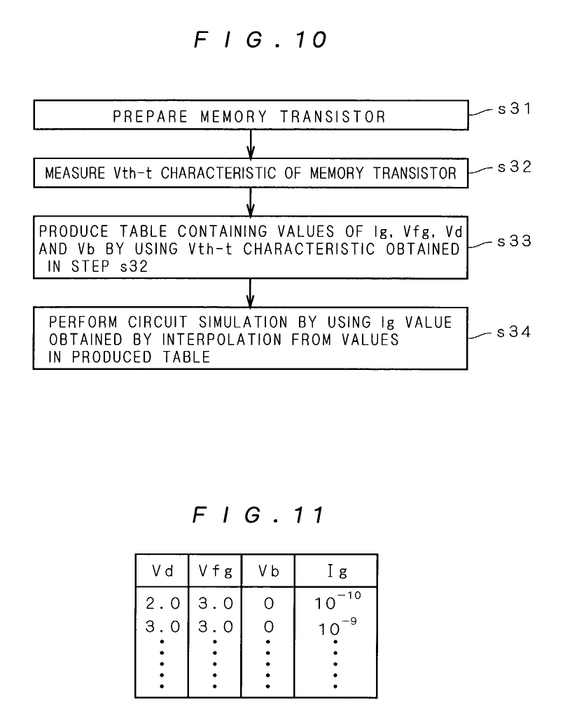

As shown in FIG. 10, a memory transistor as shown in FIG. 15 is prepared in Step s31. Specifically, a memory transistor is prepared which is manufactured under the same manufacturing conditions as a memory transistor in a semiconductor non-volatile memory product. In Step s32, the Vth-t characteristic of the prepared memory transistor is obtained by actual measurement. The Vth-t characteristic may be obtained by the same method as in Step s22 of FIG. 6. Next, in Step s33, a table containing Ig, Vfg, Vd and Vb is produced using the Vth-t characteristic obtained in Step s32. FIG. 11 is an example of the table produced in Step s33. In FIG. 11, the units of the values in the table are “V” or “A.”

Specific description is given on Step s33. The Ig-Vfg characteristic is obtained by the same method as in Step s23 of FIG. 6 using the measured Vth-t characteristic. The obtained Ig-Vfg characteristic and the settings of Vd and Vb set when the Vth-t characteristic is obtained in Step s32 are used to produce the table containing Ig, Vfg, Vd and Vb. The table having various values is produced by changing the settings of Vd and Vb and obtaining the Vth-t characteristic under the conditions after the change in Step s32.

In Step s34, the circuit simulation of the memory transistor is performed using a value of Ig obtained by interpolation from the values in the table produced in Step s33. The interpolation used herein may be, for example, linear interpolation or logarithmic interpolation.

An example of the method of obtaining the value of Ig by interpolation from the values in the table produced in Step s33 will be described using the table shown in FIG. 11. The value of Ig when Vd=2.5 V, Vfg=3.0 V and Vb=0 V is obtained, for example, by linear interpolation from the values in the table shown in FIG. 11 in the following manner.

$$Ig = \frac{{10}^{- 9} \times ( 2.5 - 2.0 ) + {10}^{- 10} \times ( 3.0 - 2.5 )}{3.0 - 2.0} = 5.5 \times {10}^{- 10} \qquad ( 14 )$$

The value of Ig when Vd=2.5 V, Vfg=3.0 V and Vb=0 V is obtained, for example, by logarithmic interpolation from the values in the table shown in FIG. 11 in the following manner.

$$\begin{matrix}Ig = exp ( \frac{log ( {10}^{- 9} ) \times ( 2.5 - 2.0 ) + log ( {10}^{- 10} ) \times ( 3.0 - 2.5 )}{3.0 - 2.0} ) \\ \approx 3.16 \times {10}^{- 10}\end{matrix} \qquad ( 15 )$$

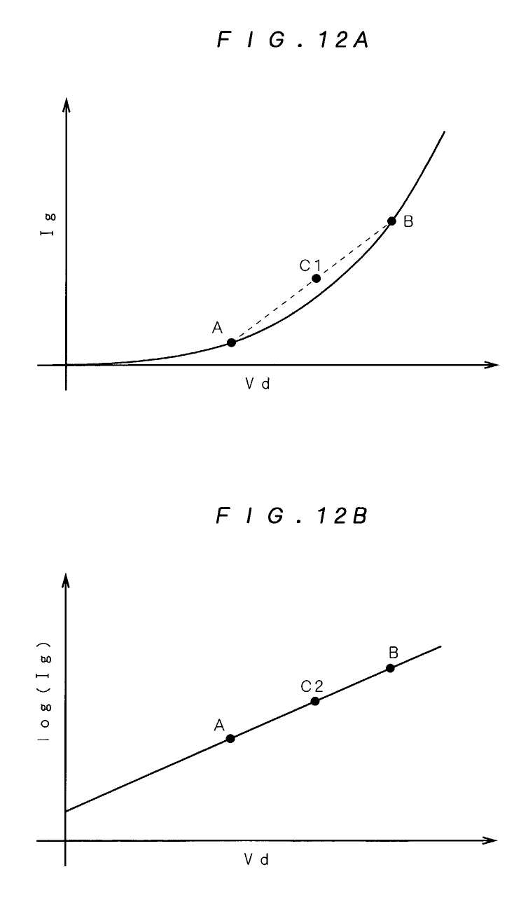

In general, the value of Ig is sensitive to changes in Vd. The measured values of the Ig-Vd characteristic plotted on a graph with both the abscissa and the ordinate on a linear scale are as shown in FIG. 12A. The measured values of the Ig-Vd characteristic plotted on a graph with the abscissa on a linear scale and the ordinate on a logarithmic scale present a substantially straight line as illustrated in FIG. 12B. The value of Ig obtained by linear interpolation using the measured values at points A and B is plotted at a point C1 on the graph, as shown in FIG. 12A, but the point C1 is deviated from the curved line indicating the Ig-Vd characteristic. The value of Ig obtained by logarithmic interpolation using the measured values at the point A and B is plotted at a point C2 on the graph, as shown in FIG. 12B. The point C2 is closer to the line indicating the Ig-Vd characteristic than the point C1. Thus, the use of the logarithmic interpolation, rather than the linear interpolation, provides the obtained value of Ig closer to the measured value to achieve more accurate interpolation of the value of Ig.

The method of simulation according to the third preferred embodiment as above described uses the Vth-t characteristic obtained by actual measurement to produce the table containing the values of Ig, Vg, Vd and Vb in Step s33. The values in the table or the values of Ig, Vg, Vd and Vb are accordingly based on the result of the actual measurement of the characteristic of the memory transistor. Then, in Step s34, the circuit simulation of the memory transistor is performed using the value of Ig obtained by interpolation from the values based on the actual measurement of the characteristic of the memory transistor. This makes the simulated value of the memory transistor close to the actually measured value. In other words, the method of simulating the memory transistor according to the third preferred embodiment can reliably cause the simulated value to approach the actually measured value of the characteristic of the memory transistor.

The method of simulation in which the value of Ig is obtained using the model equation as in the second preferred embodiment generally needs the step of adjusting the parameters in the model equation. The method of simulation according to the third preferred embodiment, however, does not require such a step since the value of Ig is obtained by interpolation from the values in the table. This shortens the time required for the simulation of the transistor.

The use of the logarithmic interpolation provides the obtained value of Ig closer to the measured value to achieve more accurate interpolation of the value of Ig than the use of the linear interpolation. Thus, the use of the value of Ig obtained by the logarithmic interpolation from the values in the table for the circuit simulation of the memory transistor provides the simulated value closer to the actually measured value than the use of the value of Ig obtained by the linear interpolation.

Fourth Preferred Embodiment

Equation (12a) described in Reference [1] is discussed in the second preferred embodiment. Equation (12a) in Reference [1] may be used for a circuit simulation of the hot electron type memory transistor. Specifically, Equation (12a) in Reference [1] may be used as the model equation representing Ig of the hot electron type memory transistor as mentioned above. Equation (12a) in Reference [1] is as follows:

$$Ig \approx 0.5 \times \frac{Ids \cdot Xox}{λ r} {( \frac{λ \cdot Em}{φ b} )}^{2} P ( Eox ) {ⅇ}^{- ( φ b / Em λ )} \qquad ( 16 )$$

Equation (12a) in Reference [1] shall be defined as Equation (16) according to a fourth preferred embodiment of the present invention.

According to Reference [1], P(Eox) and Eox in Equation (16) are expressed as follows:

When Eox≧0,

$$\begin{matrix}P ( Eox ) \approx [ \frac{5.66 \times {10}^{- 6} \cdot Eox}{( 1 + \frac{Eox}{1.45 \times {10}^{5}} )} \times \frac{1}{( 1 + \frac{2 \times {10}^{- 3}}{Leff} {ⅇ}^{( - Eox Xox / 15 )} )} + \\ 2.5 \times {10}^{- 2} ] {ⅇ}^{( - 300 / \sqrt{Eox} )}\end{matrix} \qquad \text{(17a)}$$

When Eox<0,

P(Eox)≈2.5×10⁻²e^{(-Xox/λox)} (17b)

$$Eox \approx \frac{Vfg - Vd}{Xox} \qquad ( 18 )$$

where

Ids=the current between the drain and source regions;

λ=the scattering mean free path of a hot electron;

λr=the re-direction scattering mean free path;

Xox=the thickness of the insulation film between the floating gate and the substrate;

Em=the channel electric field at an end of the drain region;

φb=the potential barrier between the substrate and the insulation film between the floating gate and the substrate;

P(Eox)=the probability of injection of the hot electron into the floating gate;

Leff=the effective channel length of the memory transistor; and

λox=the scattering mean free path in a potential well due to the image force in the insulation film between the floating gate and the substrate.

The channel electric field is an electric field in the channel region of the memory transistor in a direction parallel to the channel region. Equations (16) through (18) are suitably changed from those described in Reference [1] for use in the simulation of the memory transistor.

With reference to Equation (16), Ig is represented using Em or the channel electric field at the drain region end. Em is given by, for example, Equation (20) disclosed in C. Hu et al., “Hot-Electron-Induced MOSFET Degradation—Model, Monitor, and Improvement,” IEEE Trans. Electron Devices, Vol. ED-32, No. 2, pp. 375-385, 1985 (referred to hereinafter as “Reference [2]”). Equation (20) in Reference [2] is described below. Equation (20) in Reference [2] shall be defined as Equation (19) according to the fourth preferred embodiment.

$$Em = \frac{Vd - Vdsat}{1} \qquad ( 19 )$$

where

Vdsat=Vd at the “pinchoff” or “saturation” point; and

1=a fitting parameter.

Although Em or the channel electric field at the drain region end is used in Equation (16), a channel electric field at a point of injection of the hot electron into the floating gate is generally used, rather than Em. If Vfg is sufficiently high, the use of Em as the channel electric field at the point of injection of the hot electron into the floating gate presents no problems since the hot electron is injected from the channel region near the drain region end into the floating gate. However, the point of injection of the hot electron into the floating gate is shifted in the channel region toward the source region and away from the drain region end as Vfg decreases. The channel electric field has the maximum value at the drain region end, and decreases in proceeding from the drain region toward the source region. Thus, there may be cases where the value of Ig obtained using Em in Equation (16) significantly differs from the actually measured value, depending on the conditions of Vfg. Such a characteristic that the point of injection of the hot electron into the floating gate is shifted toward the source region as Vfg decreases is disclosed in, for example, B. Eitan et al., “Hot-Electron Injection into the Oxide in n-Channel MOS Devices,” IEEE Trans. Electron Devices, Vol. ED-28, No. 3, pp. 328-340, 1981.

FIG. 13 is a graph showing the Ig-Vfg characteristic obtained when the method of simulation according to the second preferred embodiment is carried out using Equation (16) containing Em expressed by Equation (19) as the model equation representing Ig. The dash-dot line of FIG. 13 indicates the Ig-Vfg characteristic. Circles in FIG. 13 indicate values based on the result of actual measurement of the characteristic of the memory transistor or, specifically, values obtained by the same method as in Step s23 of FIG. 6.

The Ig-Vfg characteristic indicated by the dash-dot line in FIG. 13 is specifically obtained in a manner to be described below. The values of parameters in Equation (16) are adjusted so that the Ig-Vfg characteristic obtained from the actually measured Vth-t characteristic or the Ig-Vfg characteristic indicated by the circles in FIG. 13 coincides with the Ig-Vfg characteristic obtained by simulation using Equation (16). After the adjustment, a simulation is performed using Equation (16) to obtain the Ig-Vfg characteristic. The parameters adjusted in Equation (16) are λ, λr, φb, P(Eox) and 1. For P(Eox), constants in Equations (17a) and (17b) are also adjusted. More specifically, the adjusted constants are “5.66×10⁻⁶,” “1.45×10⁵,” “2×10⁻³” and “2.5×10⁻²” in Equation (17a) and “2.5×10⁻²” and λox in Equation (17b). In FIG. 13, “α” represents a set voltage value of Vd.

As illustrated in FIG. 13, when Em is used, there is little difference between the Ig-Vfg characteristic (indicated by the dash-dot line in FIG. 13) obtained by simulation and the Ig-Vfg characteristic (indicated by the circles in FIG. 13) based on the result of the actual measurement of the characteristic of the memory transistor if the value of Vfg is greater than the set voltage value α of Vd, whereas the difference between the Ig-Vfg characteristic obtained by simulation and the Ig-Vfg characteristic based on the result of the actual measurement of the characteristic of the memory transistor tends to increase if the value of Vfg is less than the set voltage value α of Vd.

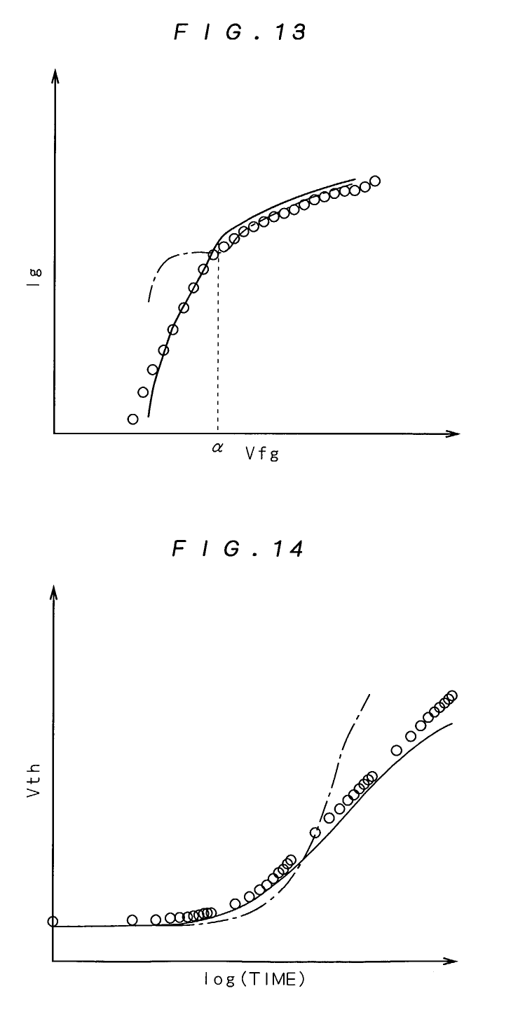

FIG. 14 is a graph showing the Vth-t characteristic of the memory transistor. Circles in FIG. 14 indicate values actually measured by the same method as in Step s22 of FIG. 6. The dash-dot line of FIG. 14 indicates simulated values obtained when the method of simulation according to the second preferred embodiment is carried out using Equation (16) containing Em expressed by Equation (19) as the model equation representing Ig, in a manner similar to the Ig-Vfg characteristic indicated by the dash-dot line in FIG. 13.

As illustrated in FIG. 14, the Vth-t characteristic of the memory transistor shows that the simulated values indicated by the dash-dot line greatly differ from the actually measured values indicated by the circles and that the difference between the simulated values indicated by the dash-dot line and the actually measured values indicated by the circles tends to increase as the electron injection time increases above certain time.

In this manner, the use of Em as the channel electric field at the point of injection of the hot electron into the floating gate in Equation (16) does not provide a good simulation result if the value of Vfg is less than the value of Vd.

In view of characteristics such that the point of injection of the hot electron into the floating gate in the channel region is shifted toward the source region as Vfg decreases and that the channel electric field decreases in proceeding from the drain region toward the source region, the method of simulation according to the fourth preferred embodiment represents the channel electric field at the point of injection of the hot electron into the floating gate in the channel region by means of the following model equation to perform the circuit simulation of the memory transistor by the use of the model equation.

When Vfg>Vd−V1,

E=(Vd−Vdsat)/lc (20a)

When Vfg≦Vd−V1,

E=(Vd−Vdsat)/lc×(1−a×(Vd−Vfg−V1)/(Vd+c)) (20b)

where

E=the channel electric field at the point of injection of the hot electron into the floating gate in the channel region; and

V1, lc, a, c=fitting parameters.

The value of E expressed by Equation (20b) can be made less than the value of E expressed by Equation (20a) or the value of the channel electric field at the drain region end by adjusting the fitting parameters a and c.

The Ig-Vfg characteristic obtained when the method of simulation according to the second preferred embodiment is carried out using Equation (16) containing E expressed by Equations (20a) and (20b) is indicated by the solid line of FIG. 13. The parameter adjustment in Equation (16) is performed also on V1, lc, a and c. The Vth-t characteristic obtained when the method of simulation according to the second preferred embodiment is carried out using Equation (16) containing E expressed in Equations (20a) and (20b) in place of Em is indicated by the solid line of FIG. 14.

For the hot electron type memory transistor, the use of E expressed by Equations (20a) and (20b) as the channel electric field at the point of injection of the hot electron into the floating gate provides more accurate simulated values of Ig over a wide range of Vfg than the use of Em, as illustrated in FIG. 13. This allows the simulated value to reliably approach the actually measured value to provide a good simulation result, as illustrated in FIG. 14.

While the invention has been described in detail, the foregoing description is in all aspects illustrative and not restrictive. It is understood that numerous other modifications and variations can be devised without departing from the scope of the invention.

What is claimed is:

1. A method of simulating a memory transistor including a control gate, a floating gate, and a substrate having a source region and a drain region formed in a surface thereof, said floating gate and said substrate constituting a MOS transistor structure, said method comprising the steps of:
(a) preparing said memory transistor;
(b) obtaining a relationship between a potential of said control gate with respect to said source region and a drain current by actual measurement for said memory transistor;
(c) preparing a standard transistor having the same structure as said MOS transistor structure of said memory transistor;
(d) obtaining a relationship between a potential of said floating gate with respect to said source region and a drain current by actual measurement for said standard transistor; and
(e) determining a capacitance value defined between said control gate and said floating gate in said memory transistor for use in a circuit simulation of said memory transistor, based on a result obtained in said step (b) and a result obtained in said step (d),
wherein the circuit simulation of said memory transistor is performed using said capacitance value determined in said step (e).

2. A method of simulating a memory transistor including a control gate, a floating gate, and a substrate having a source region and a drain region formed in a surface thereof, said floating gate and said substrate constituting a MOS transistor structure, said method comprising the steps of:
(a) preparing said memory transistor;
(b) obtaining a relationship between a threshold voltage and one of the time for which an electron is injected into said floating gate and the time for which an electron is emitted from said floating gate by actual measurement for said memory transistor;
(c) obtaining a relationship between a gate current flowing between said floating gate and a channel region defined between said source region and said drain region, and a potential of said floating gate with respect to said source region for said memory transistor by using a result obtained in said step (b); and
(d) determining a value of a parameter in a model equation representing said gate current, based on a result obtained in said step (c),
wherein a circuit simulation of said memory transistor is performed using said model equation in which said value determined in said step (d) is substituted for said parameter.

3. The method according to claim 2, further comprising the steps of:
(e) obtaining a relationship between a potential of said control gate with respect to said source region and a drain current by actual measurement for said memory transistor;
(f) preparing a standard transistor having the same structure as said MOS transistor structure of said memory transistor; and
(g) obtaining a relationship between a potential of said floating gate with respect to said source region and a drain current by actual measurement for said standard transistor,
wherein the relationship between said gate current and the potential of said floating gate with respect to said source region is obtained in said step (c) by using results obtained in said steps (b), (e) and (g).

4. The method according to claim 2, wherein
said model equation representing said gate current is expressed by the product of a polynomial involving the potential of said floating gate with respect to said source region for said memory transistor, a polynomial involving a potential of said drain region with respect to said source region for said memory transistor, and a polynomial involving a potential of said substrate with respect to said source region for said memory transistor.

5. The method according to claim 3, wherein
said model equation representing said gate current is expressed by the product of a polynomial involving the potential of said floating gate with respect to said source region for said memory transistor, a polynomial involving a potential of said drain region with respect to said source region for said memory transistor, and a polynomial involving a potential of said substrate with respect to said source region for said memory transistor.

6. A method of simulating a memory transistor including a control gate, a floating gate, and a substrate having a source region and a drain region formed in a surface thereof, said memory transistor storing information therein by injection of a hot electron from a channel region defined between said drain region and said source region into said floating gate, said method comprising
performing a circuit simulation of said memory transistor using a model equation representing a channel electric field at a point of injection of said hot electron into said floating gate in said channel region,
said model equation being expressed by
E=(Vd−Vdsat)/lc
for Vfg>Vd−V1, and
E=(Vd−Vdsat)/lc×(1−a×(Vd−Vfg−V1)/(Vd+c))
for Vfg≦Vd−V1,
where
E=the channel electric field at the point of injection of said hot electron into said floating gate in said channel region;
Vfg=a potential of said floating gate with respect to said source region;
Vd=a potential of said drain region with respect to said source region;
Vdsat=a potential of said drain region with respect to said source region at pinchoff; and
V1, 1c, a and c=fitting parameters.

7. The method according to claim 4, wherein
said model equation representing said gate current is expressed by
Ig=A(Vfg−B)^{c}×Vd^{D}×Vb^{E}
where
Ig=the gate current;
Vfg=the potential of said floating gate with respect to said source region for said memory transistor;
Vd=the potential of said drain region with respect to said source region for said memory transistor;
Vb=the potential of said substrate with respect to said source region for said memory transistor; and
A, B, C, D and E=parameters.

8. The method according to claim 1, wherein
said memory transistor constitutes a memory cell of a flash memory.

9. The method according to claim 2, wherein
said memory transistor constitutes a memory cell of a flash memory.

10. The method according to claim 6, wherein
said memory transistor constitutes a memory cell of a flash memory.
